(19) United States
(12) Patent Application Publication
(10) Pub. No.: US 2010/0090183 A1
(43) Pub. Date: Apr. 15, 2010

(54) APPARATUS FOR USE IN ADVANCING A CABLE THROUGH A CONDUIT

(76) Inventors: Ross Leto, Bossley Park (AU); Vincenza Leto, Bossley Park (AU)

Correspondence Address: SUGHRUE MION, PLLC, 2100 PENNSYLVANIA AVENUE, N.W., SUITE 800, WASHINGTON, DC, 20037, US

(21) Appl. No.: 12/529,479

(22) PCT Filed: Mar. 4, 2008
(86) PCT No.: PCT/AU2008/000292

§ 371 Date: Dec. 22, 2009

(30) Foreign Application Priority Data
Mar. 5, 2007 (AU) 2007901127

(51) Int. Cl. H02G 1/08

(52) U.S. Cl. 254/134.3 FT

(57) ABSTRACT

An apparatus for use in passing a cable through a conduit, the apparatus including:
a cable roller;
a mounting means for mounting the cable roller adjacent an opening of the conduit; and
a cable guide for directing the cable into engagement with the cable roller as the cable is being fed into or retracted out of the conduit, wherein, the cable roller is adapted to rotate when engaged with the cable so as to assist in providing a smooth advancement of the cable into or out of the conduit opening.

### TECHNICAL FIELD

The present invention relates to an apparatus for use in laying cables in conduits.

### BACKGROUND OF THE INVENTION

Cables need to be laid in conduits in a number of situations. For instance, relatively heavy telecommunications cables may be laid in a conduits running along suburban streets, or, relatively light-weight electrical cables may need to be laid in conduits running within the walls of a home. Typically, cable laying may involve pulling the cable through the conduit system either manually, or, with a machine. In either case, similar problems arise in the course of laying the cables in the conduits.

The main problem associated with laying cable in conduits is that as the cable is being pulled through the conduits the friction which arises between the moving cable and conduit tends to result in erosion of the conduit and or cable materials. Friction is exacerbated where the conduit system is non-linear in nature and thus requires the cable to rub against multiple sharp corners. Erosion of the conduit underground is undesirable as this leaves the cable exposed to potentially damaging external elements such as ground-water and the like. On the other hand, erosion of the cable may result in performance-loss in the use of the cable. The weight of the cable and the friction between the cable and conduit also tends to result in stretching and warping of the cable as it is pulled through the conduit—once again, this may result in a performance loss.

Various prior art approaches have been taken in attempting to address the above-discussed problem. In particular, cable rollers have been positioned at the openings of conduits wherein the cable rollers essentially consist of a spool shaped rotatable roller against which the cable abuts when it is pulled out of or into the conduit opening.

Rotational movement of the roller as the cable passes over it assists in alleviating the required pulling force of the user pulling the cable. Unfortunately, these cable rollers tend to be difficult to use because the cables often slip off the cable roller as the user moves about relative to the conduit opening.

A further prior art technique used to assist in advancing the cable through the conduit has been for the user to lubricate the surface of the cable as it is being fed into the conduit opening. This usually involves the user applying an amount of lubricating fluid to his/her hand and then manually rubbing a surface of the cable. Unfortunately, this is a cumbersome, tedious and messy process.

### SUMMARY OF THE INVENTION

The present invention seeks to alleviate at least one of the problems discussed above in relation to the prior art.

The present invention involves several different broad forms. Embodiments of the invention may include one or any combination of the different broad forms herein described.

In a first broad form, the present invention provides an apparatus for use in passing a cable through a conduit, the apparatus including:
a cable roller;
a mounting means for mounting the cable roller adjacent an opening of the conduit; and
a cable guide for directing the cable into engagement with the cable roller as the cable is being fed into or retracted out of the conduit, wherein, the cable roller is adapted to rotate when engaged with the cable so as to assist in providing a smooth advancement of the cable into or out of the conduit opening.

Preferably, the mounting means includes a hollow tube having a first end and a second end. Typically, the cable roller may be rotatably mounted to the first end of the hollow tube around a pivot pin. Typically, the first end of the hollow tube may include a flanged region.

A second end of the hollow tube may be adapted for insertion into the opening of the conduit. For instance, the second end of the hollow tube may be contoured to complement an internal shape characteristic of the conduit when inserted therein. Advantageously, this may provide a relatively snug fit so that the cable roller may sit adjacent the conduit opening in a relatively fixed position.

Preferably, the hollow tube may also include a sidewall having an elongate slot disposed therein.

Preferably, the cable guide may include an annular ring.

Preferably, the cable guide may be mounted to the cable roller via a bracket.

Typically, the bracket may include an L-shaped configuration having a first region, and, a second region which is substantially perpendicular to the first region.

The first region of the bracket may include an aperture via which the elongate section of the hollow tube may be fed through until the flanged region of the first end of the hollow tube comes to rest flush against a surface of the first region of the bracket. Typically, the flanged region of the first end of the hollow tube may include a plurality of locating pins which are adapted for releasable engagement with a plurality of corresponding locating apertures disposed in the first region of the bracket when the first end of the hollow tube is abutting flush against the first region of the bracket. It would be understood that in alternative embodiments, the locating pins may be disposed on the bracket whilst the locating apertures may be disposed on the first end of the hollow tube.

The second region of the bracket may include a notch in which the cable guide may be rotatably mounted around a second pivot pin. Typically, when the cable guide is mounted relative to the cable roller, an axis of rotation of the cable guide around the pivot pin may be substantially in alignment with an axis of rotation of the cable roller. However, in certain embodiments of the present invention it is conceivable that the cable guide may be rotatable around multiple axes and may not necessarily have an axis in alignment with the axis of the cable roller.

The cable guide may be detachably mountable to the second region of the bracket so that a range of different cable guides having different dimensions may be interchangeably attached to the mounting plate in order to more flexibly accommodate a range of different cable diameters if required.

Advantageously, the inclusion of a cable guide assists in keeping cables from slipping off the cable roller in use as the cables are being pulled out of or into the conduit opening. Moreover, if multiple cables are to be fed through a conduit simultaneously, the cable guide may be particularly useful in keeping multiple strands of cable from becoming entangled and/or becoming separated from each other as they engage with the cable roller. It is also noted that the present invention may be more flexible over at least some of the prior art in that a user may not be required to stand directly in line with the opening of the conduit as he is pulling the cable out of the conduit over the cable roller. That is, the user may stand at various angles relative to the conduit opening when pulling the cable as the cable guide directs the cable over the cable roller regardless as to where the user is standing relative to the conduit opening. In contrast with prior art cable rollers, if the user is standing off to the side of the conduit opening, the cable will slip off the cable roller when pulled due to the lack of alignment between the user, the cable roller and the conduit opening.

Preferably, the cable guide may be mounted to the cable roller such that in use, when the cable is advancing either into or out of the conduit, the cable at least partially abuts downwardly upon the curved surface of the cable roller. Advantageously, when the cable guide directs the cable into engagement around the cable roller in this manner, the cable roller may provide a degree of mechanical advantage in pulling the cable out of the conduit opening.

Preferably, the present invention may also include a winch assembly to assist a user in pulling the cable through the conduit. Typically, the winch assembly may include a winch spool and a spool lever to allow a cable or a guide wire attached to the cable to be pulled through the conduit through the winding action of the winch assembly. If a guide wire is used, the guide wire may typically be coupled to a leading end of the cable to be pulled through the conduit.

A winch lever may be operably coupled to the winch spool in order for a user's hand to more conveniently wind the spool. Typically, the winch assembly may be mounted relative to the conduit opening such that when the cable or guide wire being wound up exits the conduit opening, it pass over the cable roller and through the cable guide before being wound onto the winch spool.

The use of the cable guide may provide further advantages for the present invention particularly when the winch assembly is in use. That is, in the event that the guide wire snaps during pulling of the cable through the conduit, the cable guide may protectively arrest any potentially dangerous backlash of the guide wire should the guide wire snap.

Typically, the winch assembly may be mounted on a base plate which typically includes a rectangular-shaped configuration. Preferably, both the cable guide and the cable roller may also be adapted for mounting to the base plate. When mounted to the base plate, the winch assembly is typically arranged at a first end of the base plate, the cable roller is arranged at a second opposing end of the base plate with the hollow tube extending through the base plate via an aperture in substantially perpendicular fashion, and, wherein the cable guide may be mounted to the base plate between the winch assembly and the cable roller. The locating pins extending from the hollow tube may not only engage with the locating apertures disposed in the bracket, but also with corresponding locating apertures disposed in the base plate so that the locating pins hold the bracket and the base plate together as a single unit.

Typically, the winch assembly may be adapted to provide at least about a 4-to-1 ratio drive with a manual free spool lever.

In certain embodiments, the present invention may further include a lubricating means adapted for lubricating a surface of a cable prior to the cable being fed into the conduit. Typically, the lubricating means includes a tube-shaped configuration. The tube-shaped configuration may include a rubber material or otherwise resiliently expandable material so that a number of different cable diameters may be snugly accommodated within the same tube-shaped configuration. Alternatively, the tube-shaped configuration may include a substantially rigid material such as metal.

Typically, the tube-shaped configuration includes first and second openings disposed at opposing first and second ends of the tube-shaped configuration respectively. Preferably, the first and second openings may be covered by diaphragms having resiliently expandable apertures disposed therein such that the cable is able to pass through the diaphragm covering the first opening, through the tube-configuration, and then out of the aperture disposed on the second diaphragm at the second opening.

Preferably, the tube-shaped configuration includes an inlet via which a supply of lubricant may be fed into the tube-shaped configuration. Typically the inlet may be adapted for interfacing with the external supply of lubricant such that the lubricant may be continuously fed into the tube-shaped configuration via a pumping means, by a gravity means or the like, or, manually fed into the tube-shaped configuration by a user. In certain embodiments, the inlet or pump means may be adjustable so that a rate of flow of the lubricant into the tube-shaped configuration may be controlled. The pump may include a hand pump or a foot pump for instance. This may be convenient in that different sized cables may require different amounts of lubricant to be applied at different rates.

Preferably, in use the lubricating means may be mounted relative to the cable roller and cable guide whereby the lubricating means is disposed between the cable roller and the cable guide. In this regard, the lubricating means may typically be mounted to the bracket to which the cable roller and cable guide may be fixed. Typically, the first end of the tube-shaped configuration may be disposed adjacent to the cable roller whilst the second end of the tube-shaped configuration may be disposed adjacent to the cable guide.

Advantageously, the use of the lubricating means alleviates the need for the user to waste time in manually lubricating the surface of the cable by hand before the cable enters the conduit. The present invention may also provide a relatively less messy approach to lubricating the cable surface compared to prior art techniques whereby the user may not necessarily be required to rub the lubricant over the cable by hand as the cable is being fed into the conduit.

In a second broad form, the present invention provides a cable guide adapted for use with a cable roller positionable adjacent a conduit opening, the cable guide being adapted for directing a cable into engagement with the cable roller as the cable is being fed into or retracted out of the conduit opening, wherein, the cable roller is adapted to rotate when engaged with the cable so as to assist in providing a smooth advancement of the cable into or out of the conduit opening.

In a third broad form, the present invention provides a lubricating means having a sidewall surrounding a hollow core, wherein a cable is able to be slidably received within the hollow core as the cable is being fed therethrough prior to entry into an opening of a conduit, and a lubricant dispensing means is disposed on the sidewall to allow lubricant to be controllably dispensed on to a surface of the cable passing through the hollow core.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 depicts a side view of a first embodiment of the present invention including a cable roller, a cable guide and a winch assembly mounted to a mounting plate;

FIG. 2 depicts a perspective view of the first embodiment of the present invention including a cable roller, a cable guide and a winch assembly mounted to a mounting plate;

FIG. 3 depicts a perspective view of the base plate with the winch assembly and the bracket attached, but without the cable roller or cable guide attached.

FIG. 4 depicts a perspective view of a cable roller in stand-alone form as used in accordance with the first embodiment;

FIG. 4A depicts a side view of a cable roller rotatably coupled to a first flanged end of a mounting means in stand-alone form as used in accordance with the first embodiment;

FIG. 5 depicts a front view of a cable guide in stand-alone form as used in accordance with the first embodiment, the able guide being embodied by an annular ring;

FIG. 6 depicts a perspective view of a bracket adapted for releasably coupling the cable roller and cable guide together;

FIG. 7 depicts a side view of a lubricating means as used in accordance with the first broad form of the present invention;

FIG. 8 depicts a front perspective view of the lubricating means shown in FIG. 7;

FIG. 9 depicts a reverse perspective view of the lubricating means shown in FIG. 8;

FIG. 10 shows a preferred embodiment of a stand alone cable roller device in accordance with the present invention;

FIG. 11 illustrates a preferred embodiment of apparatus in accordance with the preferred embodiment of the present invention, into which the cable roller unit of FIG. 10 is adapted to be inserted;

FIG. 12 details the mounting means and cable guide of the apparatus shown in FIG. 11;

FIG. 13 details section A-A FIG. 12, showing the mounting of the cable roller drum; and,

FIG. 14 shows how the winch handle may be mounted to assist in the manual drawing of the cable.

### DETAILED DESCRIPTION OF PREFERRED EMBODIMENTS

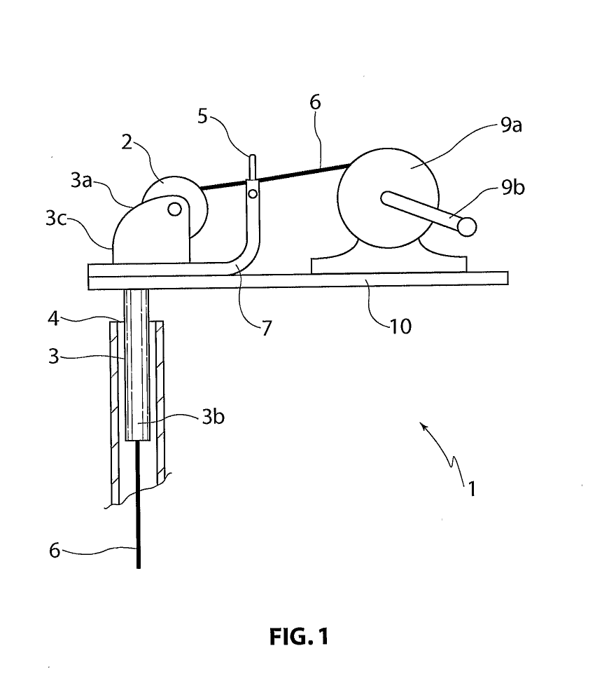

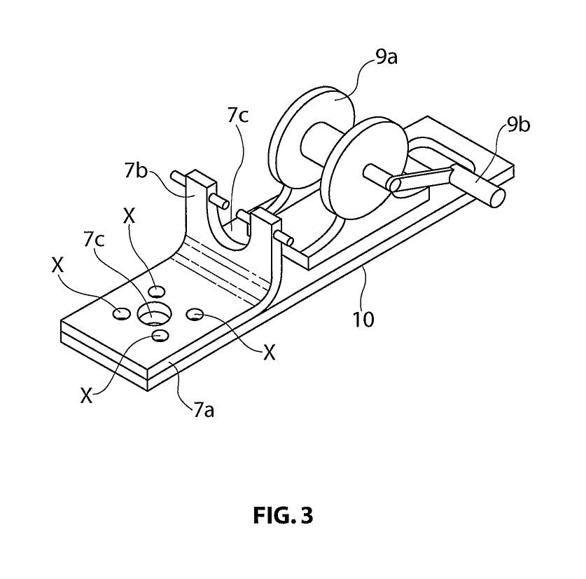

A first embodiment apparatus will now be described in detail by reference to FIGS. 1 to 9.

Referring firstly to FIGS. 1 to 3, the apparatus (1) includes a cable roller (2), a sleeve or mounting means (3) for mounting the cable roller or roller drum (2) adjacent an opening (4) of the conduit, and, a cable guide (5) for directing the cable (6) into engagement with the cable roller (2) as the cable (6) is being fed into or retracted out of the conduit opening (4). The cable roller (2) is adapted to rotate when engaged with the cable (6) so as to assist in providing a smooth advancement of the cable (6) into or out of the conduit opening (4).

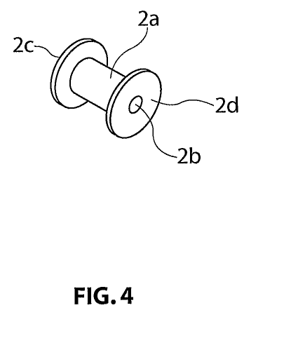

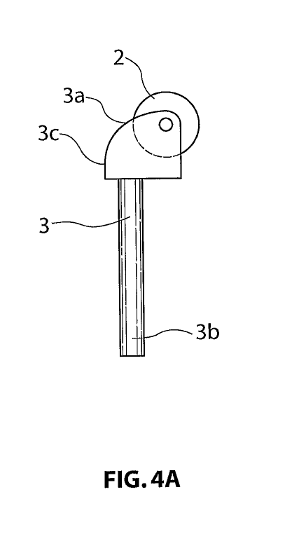

The cable roller (2) is shown in stand-alone form in FIG. 4 and includes a spool shaped roller having a cylindrical shaped body (2a), a hollow core (2b) and expanded first and second ends (2c, 2d).

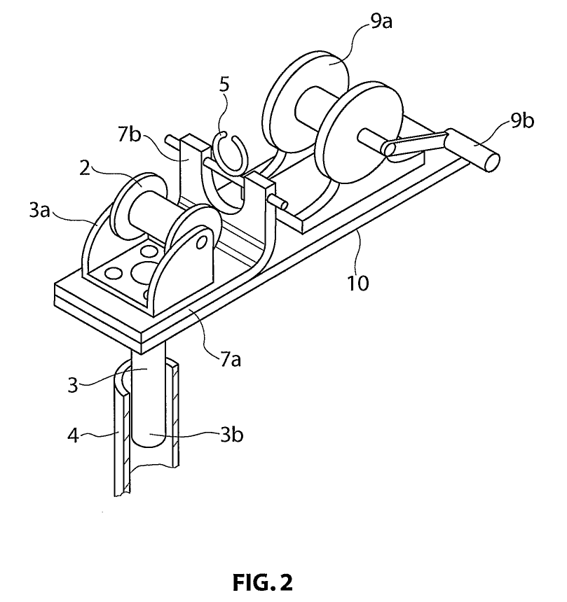

The cable roller (2) is positionable adjacent the conduit opening (4) by use of a mounting means (3), which in this embodiment includes a hollow tube (3). In FIG. 4A, the cable roller (2) is shown rotatably coupled to a first flanged end (3a) of the hollow tube (3) by a first pivot pin. The hollow tube (3) also includes a second cylindrically-shaped end (3b) which is adapted for insertion into the circular-shaped conduit opening (4) as shown in FIGS. 1 and 2. The second end (3b) of the hollow tube (3) is contoured to complement the internal shape characteristic of the conduit when inserted therein. An elongate slot (3c) is disposed in a sidewall of the hollow tube (3) as indicated in FIG. 4A.

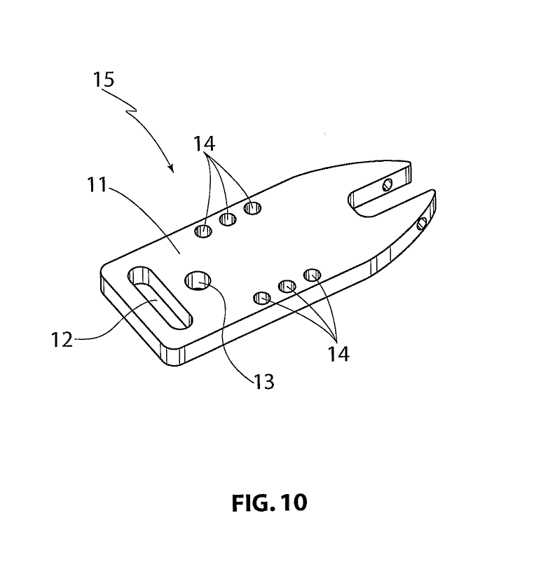

The cable roller device, depicted in FIG. 4A, may be utilised in stand-alone form, that is as shown in FIG. 10, whereby the device may be used without the base support 10, the winch assembly 9 and the cable guide 5. This is particularly suitable in situations where space to access the conduit opening 4 is very limited. It will be appreciated that in such situations, the cable may be manually drawn into or out from the conduit opening 4.

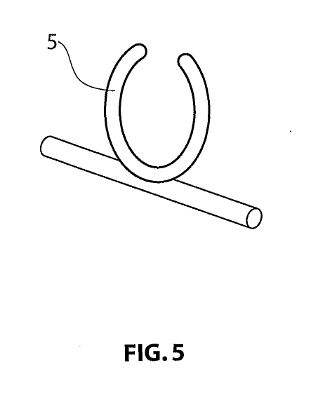

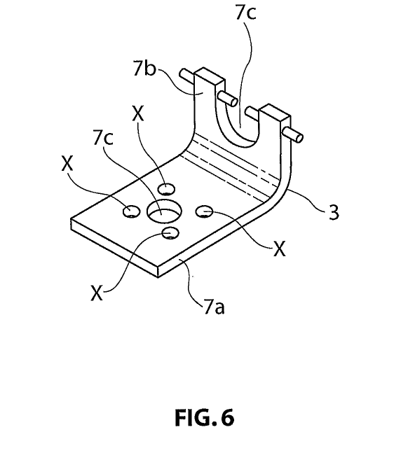

The cable guide (5) shown in FIG. 5 includes an annular ring which is detachably mountable relative to the cable roller (2) via an L-shaped bracket (7). The L-shaped bracket (7) shown in FIG. 6 includes a first region (7a), and, a second region (7b) which is substantially perpendicular to the first region (7a).

The first region (7a) of the bracket (7) includes an aperture (7c) via which the elongate section of the hollow tube (3) is able to be fed through until the flanged region (3a) of the first end of the hollow tube (3) comes to rest flush against a surface of the first region (7a) of the bracket (7). The flanged region (3a) of the first end of the hollow tube (3) includes 4 locating pins (not shown) which are adapted for releasable engagement with 4 corresponding locating apertures (X) disposed in the first region (7a) of the bracket (7) when the first end (3a) of the hollow tube (3) is abutting flush against the first region (7a) of the bracket (7) as shown in FIGS. 1 and 2.

The second region (7b) of the bracket (7) includes a notch (7d) in which the cable guide (5) is rotatably mounted around a second pivot pin. When the cable guide (5) is mounted relative to the cable roller (2) the axis of rotation of the cable guide (5) around the pivot pin is in substantially parallel alignment with the axis of rotation of the cable roller (2). The cable guide (2) can be easily detached from the bracket (7) by removing the pivot pin so that other cable guides of differing dimensions are able to be mounted in its place if desired to accommodate different sized cables.

The first embodiment also includes a winch assembly (9) which is mounted relative to the cable roller (2) and which assists a user in winding the cable (2) through the conduit. The winch assembly (9) includes a winch spool (9a) and a spool lever (9b) to allow a cable (6) or a guide wire attached to the cable (6) to be pulled through the conduit through the winding action of the winch assembly (9). The winch assembly (9) provides at least about a 4-to-1 ratio drive with a manual free spool lever (9b).

The winch assembly (9) is mounted relative to the conduit opening (4) such that when the cable (6) or guide wire being wound up exits the conduit opening (4), it passes over the cable roller (2) and through the cable guide (5) before being wound onto the winch spool (9a).

The winch assembly (9) is mounted on a rectangular-shaped base plate (10). The cable guide (5) and the cable roller (2) are also mounted to the base plate (10) via the bracket (7). That is, the first region (7a) of the bracket (7) sits flush against a surface of the base plate (10) so that the cable roller (2) sits at a first end of the base plate (10), the cable guide (5) sits above a middle region of the base plate (10) and the winch assembly (9) sits at a second end of the base plate (10). The elongate section of the hollow tube (3) to which the cable roller (2) is attached protrudes through an aperture in the base plate (10) and the 4 locating pins disposed on the hollow tube (3) are received concurrently by the 4 locating apertures (X) in the bracket (7) as well as another 4 locating apertures (not shown) disposed in the base plate (10). The locating apertures in the bracket (7) and the locating apertures disposed in the base plate (10) should be positioned so that they overlay neatly upon each other to enable the locating pins to pass through them simultaneously.

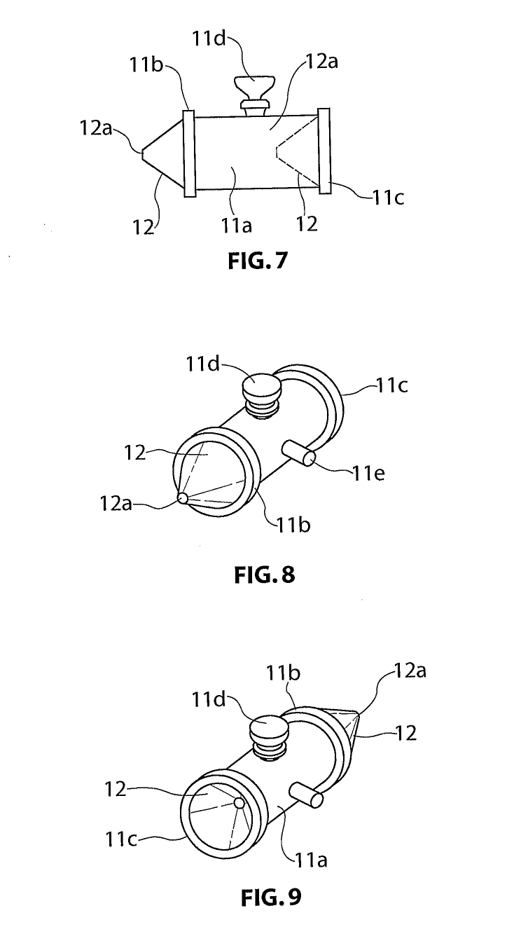

Referring now to FIGS. 7-9, the first embodiment also includes a lubricating means (11) adapted for lubricating a surface of a cable (6) prior to the cable (6) being fed into the conduit opening (4). The lubricating means (11) includes a metallic tube-shaped body (11a) having a first and second end (11b,11c).

The tube-shaped body (11a) includes first and second openings disposed at opposing first and second ends (11b,11c) respectively. The first and second openings are covered by diaphragms (12) having resiliently expandable apertures (12a) substantially at their centres to enable cables of different diameters to pass through the diaphragms (12a). The diaphragms (12) are made from resiliently expandable rubber films.

The tube-shaped body (11a) includes an inlet (11d) via which a supply of lubricant is able to be fed into the tube-shaped body (11a) and on to the cable passing through. The inlet (11d) is able to be interfaced with the external supply of lubricant which can then be continuously fed into the tube-shaped configuration (11a) via a pump. In use, the lubricating means (11) is positioned between the cable guide (5) and the cable roller (2).

In this embodiment, the inlet (11d) includes a funnel. A canister of lubricating fluid is suspended above the funnel (11d) and allowed to gradually drain into the tube-shaped configuration (11a) via the funnel (11d).

As shown in FIGS. 8 and 9, a pivoting member (11e) extends outwardly of the tube-shaped configuration (11a) which is able to assist in mounting to the L-shaped bracket (7) between the cable roller (2) and the cable guide (5) in use.

FIGS. 10 to 14 illustrate a second embodiment of the invention.

As shown in FIG. 10, a cable roller device may be used in stand alone form, wherein the device 15 includes a cable roller drum 11 supported by a securing pin 12 on a cable roller cable 13. The device is adapted to be inserted into the opening of a conduit by conduit locating sleeve 14. The device 15 is particularly usefully used by itself in situations where space is limited, to allow the easy ingress and egress of cables to and from a conduit without undue forces being applied to the cable or the conduit.

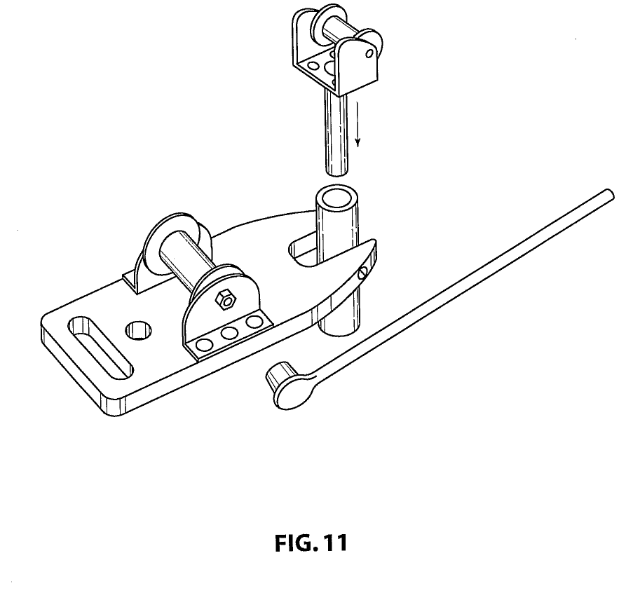

FIG. 11 shows the entire apparatus 16, including the cable roller device 15 of FIG. 10, and also a mounting means or base plate 17. The mounting means includes a swivel guide 18 at one end thereof into which the device 15 is inserted. It also includes a cable guide or roller unit 19, to which a winch handle 20 may be attached. In use, the swivel guide 18 may be placed into the opening of a conduit and is located by inserting the device 15 into the guide 18. The mounting means may then be swiveled into any position or be wall mounted if desired. Pull in metal twine may then be released from the cable guide 19 by engaging the free spool action lever. The twine may then be passed over the roller drum 11 and pulled through the guide 18 into the conduit or enclosure. On exiting the conduit or enclosure at the opposite end the twine is connected to the designated cables via a twine cable connection lug at the end of the twine. The free spool may then be disengaged, and the handle or ratchet lever 20 may then be attached. The lever 20 may then be operated so as to receive the twine and the cable attached to the twine.

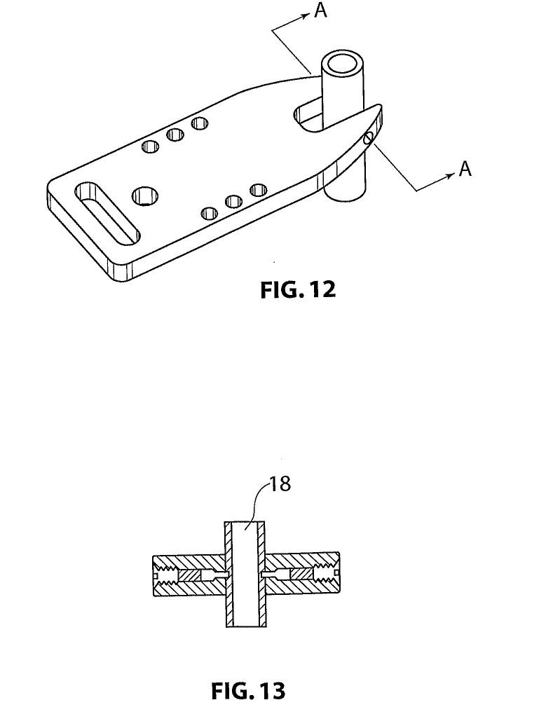

FIG. 12 details the mounting or base plate, such that the various mounting holes can be viewed.

FIG. 13 details a sectional view through line A-A of FIG. 12, showing the use of swivel guide securing pins to pivotally support the guide 18 in position. This may be achieved by using tension pins or other biasing means.

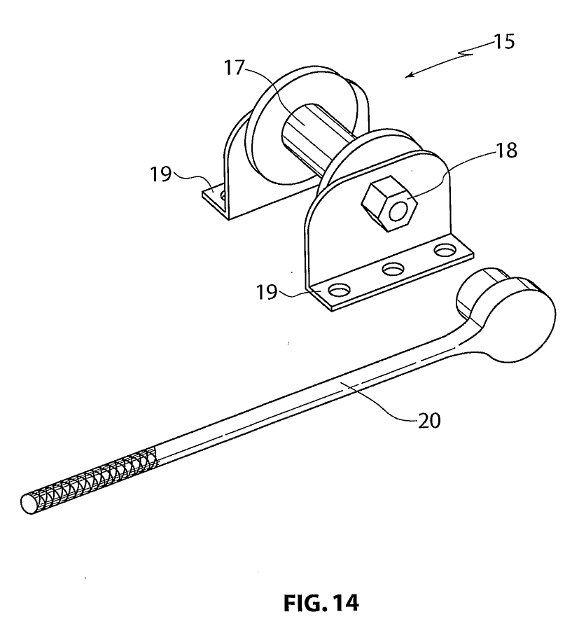

FIG. 14 illustrates the winch drum, showing how it may be supported by a pair of opposed mounting side plates, and be rotated through a winch turning nut by a ratchet winch lever bar.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A cable roller device for assisting the ingress or egress of a cable into or out of a conduit, said cable roller including:
a sleeve, having a first end adapted to be inserted into an end of a conduit; a
cradle attached to a second end of said sleeve; and,
a roller drum, supported by said cradle, adapted to rotate as said cable is drawn into or out of said conduit.

2. An apparatus for assisting the ingress or egress of a cable into or out of a conduit, said apparatus including:
a cable roller device, including:
a sleeve, having a first end adapted to be inserted into an end of said conduit;
a cradle attached to a second end of said sleeve;
a roller drum, supported by said cradle, adapted to rotate as said cable is drawn into or out of said conduit; and,
a cable guide, installed on a mounting means, adapted to be provided adjacent said conduit, for directing the cable into engagement with said cable roller as said cable is ingresses or egresses said conduit.

3. An apparatus as claimed in claim 2, wherein said cable guide includes a winch to draw said cable through said conduit.

4. An apparatus as claimed in claim 3, wherein said winch is manually or electrically operated.

5. An apparatus as claimed in claim 4, wherein said winch has a hand operable handle.

6. An apparatus as claimed in claim 2, wherein said mounting means is in the form of a plate having a cutout in a first end thereof to which said cable guide is attached.

7. An apparatus as claimed in claim 6, wherein said mounting plate further includes an engagement means, for engaging said mounting plate on a wall or other surface.

8. An apparatus as claimed in claim 2, wherein said mounting means further includes a handle.

9. An apparatus for use in passing a cable through a conduit, the apparatus including:
a cable roller;
a mounting means for mounting the cable roller adjacent an opening of the conduit, the mounting means includes a hollow tube having a first end and a second end, the first end of the hollow tube may include a flanged region; and,
a cable guide for directing the cable into engagement with the cable roller as the cable is being fed into or retracted out of the conduit, wherein, the cable roller is adapted to rotate when engaged with the cable so as to assist in providing a smooth advancement of the cable into or out of the conduit opening.

10. An apparatus as claimed in claim 9 wherein the cable roller may be rotatably mounted to the first end of the hollow tube around a pivot pin.

11. An apparatus as claimed in claim 9, wherein a second end of the hollow tube may be adapted for insertion into the opening of the conduit, including but not limited to the second end of the hollow tube being contoured to complement an internal shape characteristic of the conduit when inserted therein, to provide a snug fit so that the cable roller may sit adjacent the conduit opening in a relatively fixed position.

12. An apparatus as claimed in claim 9, wherein the hollow tube may also include a sidewall having an elongate slot disposed therein.

13. An apparatus as claimed in claim 9, wherein the cable guide may include an annular ring.

14. An apparatus as claimed in claim 9, wherein the cable guide may be mounted to the cable roller via a bracket.

15. An apparatus as claimed in claim 9, wherein the bracket may include an L-shaped configuration having a first region, and, a second region which is substantially perpendicular to the first region.

16. An apparatus as claimed in claim 9, wherein the first region of the bracket may include an aperture via which the elongate section of the hollow tube may be fed through until the flanged region of the first end of the hollow tube comes to rest flush against a surface of the first region of the bracket.

17. An apparatus as claimed in claim 9, wherein the flanged region of the first end of the hollow tube may include a plurality of locating pins which are adapted for releasable engagement with a plurality of corresponding locating apertures disposed in the first region of the bracket when the first end of the hollow tube is abutting flush against the first region of the bracket, or, the locating pins may be disposed on the bracket whilst the locating apertures may be disposed on the first end of the hollow tube.

18. An apparatus as claimed in claim 9, wherein the second region of the bracket may include a notch in which the cable guide which is rotatably mounted around a second pivot pin, and, when the cable guide is mounted relative to the cable roller, an axis of rotation of the cable guide around the pivot pin may be substantially in alignment with an axis of rotation of the cable roller, or, the cable guide is rotatable around multiple axes and may not necessarily have an axis in alignment with the axis of the cable roller.

19. An apparatus as claimed in claim 9, wherein the cable guide may be detachably mountable to the second region of the bracket so that a range of different cable guides having different dimensions are interchangeably attached to the mounting plate in order to more flexibly accommodate a range of different cable diameters if required.

20. An apparatus as claimed in claim 9, wherein, the inclusion of a cable guide assists in keeping cables from slipping off the cable roller in use as the cables are being pulled out of or into the conduit opening, whereby, if multiple cables are to be fed through a conduit simultaneously, the cable guide may be particularly useful in keeping multiple strands of cable from becoming entangled and/or becoming separated from each other as they engage with the cable roller.

21. An apparatus as claimed in claim 9, wherein the cable guide is mounted to the cable roller such that in use, when the cable is advancing either into or out of the conduit, the cable at least partially abuts downwardly upon the curved surface of the cable roller. Advantageously, when the cable guide directs the cable into engagement around the cable roller in this manner, the cable roller may provide a degree of mechanical advantage in pulling the cable out of the conduit opening.

22. An apparatus as claimed in claim 9, further including a winch assembly to assist a user in pulling the cable through the conduit said winch assembly including a winch spool and a spool lever to allow a cable or a guide wire attached to the cable to be pulled through the conduit through the winding action of the winch assembly, wherein, when a guide wire is used, the guide wire is coupled to a leading end of the cable to be pulled through the conduit.

23. An apparatus as claimed in claim 9, wherein a winch lever is operably coupled to the winch spool in order for a user's hand to more conveniently wind the spool, the winch assembly being mounted relative to the conduit opening such that when the cable or guide wire being wound up exits the conduit opening, it pass over the cable roller and through the cable guide before being wound onto the winch spool.

24. An apparatus as claimed in claim 9, wherein the winch assembly is mounted on a base plate which typically includes a rectangular-shaped configuration.

25. An apparatus as claimed in claim 9, wherein both the cable guide and the cable roller are also be adapted for mounting to the base plate, wherein, when mounted to the base plate, the winch assembly is arranged at a first end of the base plate, the cable roller is arranged at a second opposing end of the base plate with the hollow tube extending through the base plate via an aperture in substantially perpendicular fashion, and, wherein the cable guide may be mounted to the base plate between the winch assembly and the cable roller and whereby the locating pins extending from the hollow tube may not only engage with the locating apertures disposed in the bracket, but also with corresponding locating apertures disposed in the base plate so that the locating pins hold the bracket and the base plate together as a single unit.

26. An apparatus as claimed in claim 9, wherein the winch assembly is adapted to provide at least about a 4-to-1 ratio drive with a manual free spool lever.

27. An apparatus as claimed in claim 9, further including a lubricating means adapted for lubricating a surface of a cable prior to the cable being fed into the conduit, the lubricating means being of a tube-shaped configuration, including a rubber material or otherwise resiliently expandable material so that a number of different cable diameters may be snugly accommodated within the same tube-shaped configuration, or alternatively, the tube-shaped configuration including a substantially rigid material such as metal.

28. An apparatus as claimed in claim 9, wherein the tube-shaped configuration includes first and second openings disposed at opposing first and second ends of the tube-shaped configuration the first and second openings being covered by diaphragms having resiliently expandable apertures disposed therein such that the cable is adapted to pass through the diaphragm covering the first opening, through the tube-configuration, and then out of the aperture disposed on the second diaphragm at the second opening.

29. An apparatus as claimed in claim 9, wherein the tube-shaped configuration includes an inlet via which a supply of lubricant is fed into the tube-shaped configuration, the inlet being adapted for interfacing with the external supply of lubricant such that the lubricant may be continuously fed into the tube-shaped configuration via a pumping means, by a gravity means or the like, or be manually fed into the tube-shaped configuration by a user, or, the inlet or pump means being adjustable so that a rate of flow of the lubricant into the tube-shaped configuration may be controlled, the pump including a hand pump or a foot pump.

30. An apparatus as claimed in claim 9, wherein, in use the lubricating means may be mounted relative to the cable roller and cable guide whereby the lubricating means is disposed between the cable roller and the cable guide, the lubricating means being mounted to the bracket to which the cable roller and cable guide are fixed, the first end of the tube-shaped configuration being disposed adjacent to the cable roller whilst the second end of the tube-shaped configuration may be disposed adjacent to the cable guide.
